(19) United States
(12) Patent Application Publication
(10) Pub. No.: US 2025/0347153 A1
(43) Pub. Date: Nov. 13, 2025

(54) FOLDING LOCK

(71) Applicant: Cheng-Yu TSAI, CHANGHUA (TW)

(72) Inventor: Cheng-Yu TSAI, CHANGHUA (TW)

(21) Appl. No.: 18/660,371

(22) Filed: May 10, 2024

(51) Int. Cl. E05B 71/00

(52) U.S. Cl. CPC E05B 71/00

(57) ABSTRACT

A folding lock comprises a lock body having a locking structure within a sleeve assembly, a folding plate assembly, and a connecting assembly. The locking structure comprises a locking sleeve connected to the rotational shaft of a lock core through a connecting piece. The folding plate assembly has a first movable plate with an insertion protrusion having a protruding lock block, a second movable plate, and a plurality of intermediate plates connected to each other, wherein the insertion protrusion inserts upward along the Y-axis into the lock body. The locking sleeve restricts the movement of the lock block, and the sleeve assembly reinforces the structure which restricts the rotation of the locking sleeve, thereby increasing the overall structural strength to make the folding lock difficult to damage and achieve a better anti-theft effect.

### FIELD OF INVENTION

The present disclosure relates to locks, in particular to a folding lock which is difficult to be damaged.

### BACKGROUND OF THE INVENTION

Folding locks are favored by many cyclists because of their small size and portability. However, a disadvantage of folding locks is that their simple structure makes it easy for malicious individuals to use tools to damage the lock body, causing the folding lock to lose its anti-theft effect.

### SUMMARY OF THE INVENTION

Based on the above disadvantages, the purpose of the present disclosure is to provide a folding lock, in particular a folding lock that is difficult to be damaged.

According to the purpose of the present disclosure, a folding lock comprises a lock body having a locking structure disposed within a sleeve assembly. The locking structure comprises a locking sleeve and a lock core connected to each other. The lock core drives the locking sleeve to rotate back and forth along an X-axis direction. The locking sleeve has an insertion portion at one end remote from the lock core. The sleeve assembly comprises at least two sleeves each having an opening corresponding to the insertion portion, and the openings and the insertion portion are arranged along a Y-axis direction. The lock core has a keyhole arranged along a Z-axis direction; a folding plate assembly having a first movable folding plate, a second movable folding plate, and a plurality of intermediate folding plates connected to each other, wherein the first movable folding plate has an insertion protrusion inserted upward along the Y-axis direction into the insertion portion; and a connecting assembly having one end fixed inside the lock body and the other end connected to the second movable folding plate.

Wherein the sleeve assembly includes an inner sleeve, a first outer sleeve, and a second outer sleeve. The locking structure is disposed within the inner sleeve, and the first outer sleeve and the second outer sleeve are simultaneously sleeved over the outer side of the inner sleeve.

Wherein the lock body further comprises an outer casing sleeved over the outer side of the first outer sleeve, and an end cap sleeved over the outer side of the second outer sleeve.

Wherein both the inner sleeve and the first outer sleeve both have an opening corresponding to the insertion portion, and the inner sleeve has a side wall with a retaining groove that is coaxially arranged with the openings.

Wherein the second outer sleeve and the inner sleeve have corresponding insertion holes arranged along the Y-axis direction for the connecting assembly to be inserted into the lock body.

Wherein the inner sleeve further has a fixing groove coaxially arranged with the insertion hole for fixing the connecting assembly.

Wherein the connecting assembly has a fixing portion and a connecting portion. The connecting portion extends downward along the Y-axis direction from the fixing portion. The fixing portion is inserted upward along the Y-axis direction through the insertion holes and fixed inside the lock body.

Wherein both the outer casing and the end cap have an opening.

### BRIEF DESCRIPTION OF THE DRAWINGS

FIG. 1 is a schematic view of an embodiment of the present disclosure.

FIG. 2 is an exploded view of components of the embodiment of the present disclosure.

FIG. 3 is a schematic view of the locking sleeve of the present disclosure.

FIG. 4 is a cross-sectional view of the embodiment of the present disclosure in an unlocked state.

FIG. 5 is a cross-sectional view of the embodiment of the present disclosure in a locked state.

FIG. 6 is a schematic view of the folding plate assembly of the embodiment of the present disclosure in an unfolded state when unlocked.

### DETAILED DESCRIPTION OF THE PREFERRED EMBODIMENTS

In order to clearly explain the specific embodiments, structures and effects achieved by the present disclosure, the following embodiments are provided and described in conjunction with the drawings:

The descriptions of directions such as “front,” “rear,” “up,” “down,” “left,” and “right” in this text are only for convenience of understanding, and the present disclosure is not limited to these directions, but can be adjusted according to the actual situation. In the present disclosure, the up-down direction is the insertion direction (i.e., the Y-axis direction) of the first movable folding plate 51 into the lock body 10, the left-right direction is the insertion direction (i.e., the Z-axis direction) of the key 70, and the front-rear direction is the rotation direction (i.e., the X-axis direction) of the locking sleeve 12.

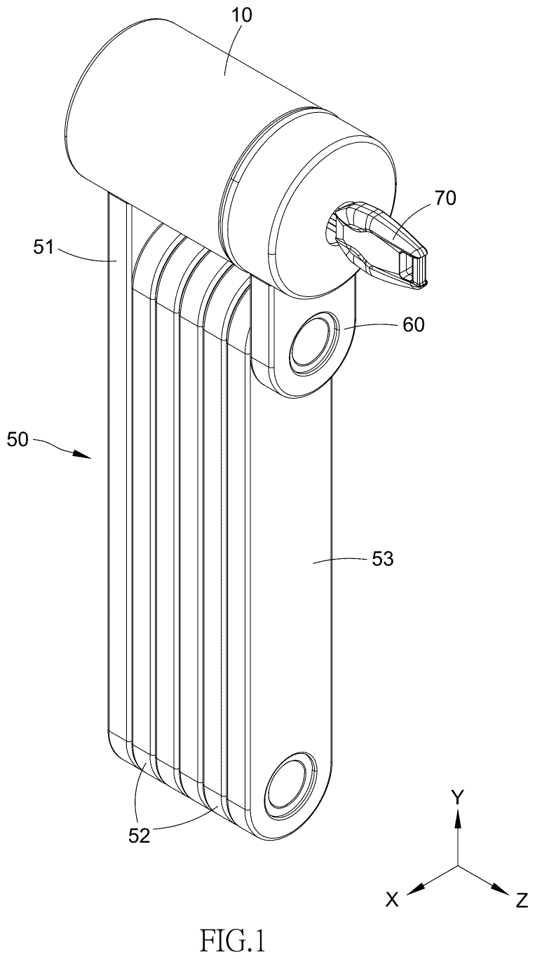

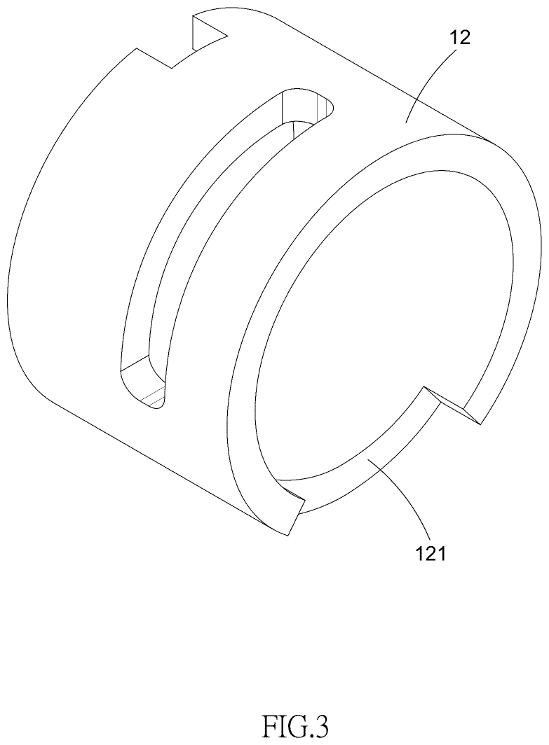

Referring to FIGS. 1 to 6, a folding lock is illustrated comprising a lock body 10, a folding plate assembly 50, and a connecting assembly 60. The folding plate assembly 50 comprises a first movable folding plate 51, a second movable folding plate 53, and a plurality of intermediate folding plates 52 connected to each other. The second movable folding plate 53 is connected to the lock body 10 through the connecting assembly 60. The plurality of intermediate folding plates 52 can be in a folded or unfolded state, and the first movable folding plate 51 has an insertion protrusion 511 that can be inserted into or pulled out of the lock body 10 to form a locked state or an unlocked state of the folding lock, wherein the second movable folding plate 53 can rotate around the axis of rotation of the connecting assembly 60.

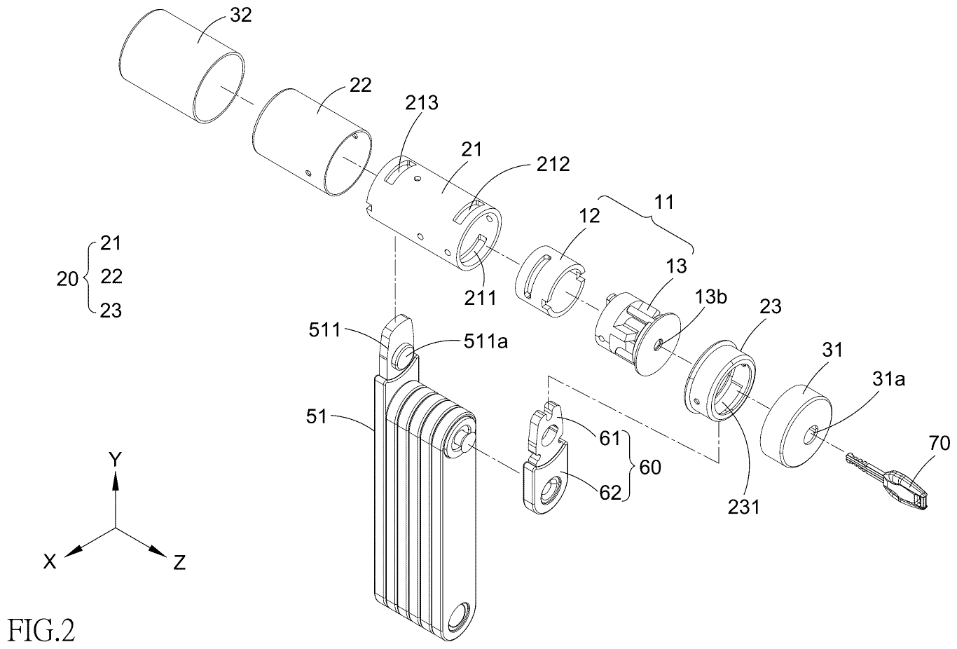

Referring to FIG. 2, the lock body 10 has a locking structure 11 disposed within a sleeve assembly 20. The locking structure 11 includes a locking sleeve 12 and a lock core 13. One end of the locking sleeve 12 is connected to a rotational shaft 13a of the lock core 13 via a connecting piece 14. The lock core 13 has a keyhole 13b for inserting a key 70, and the keyhole 13b is arranged along a Z-axis direction. When the key 70 is rotated, it causes the locking sleeve 12 to rotate back and forth along the X-axis direction together with the rotational shaft 13a.

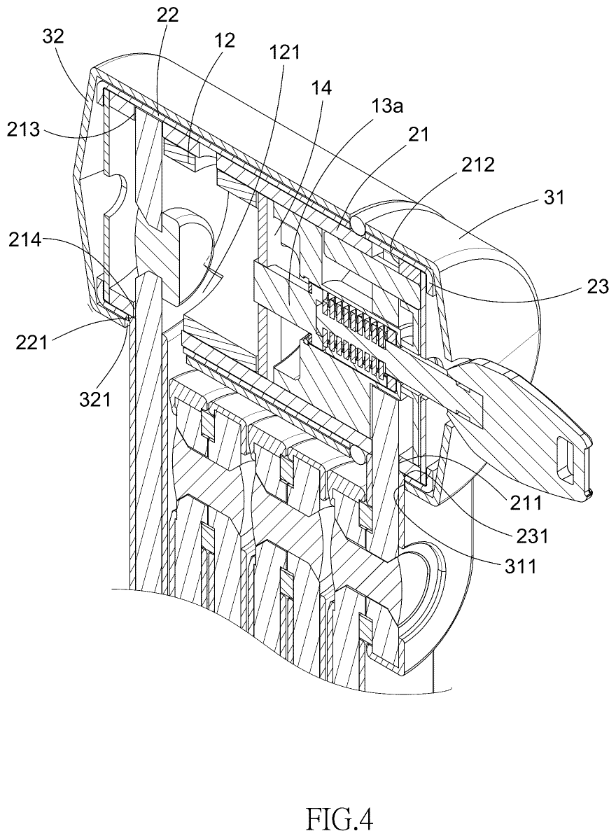

The locking sleeve 12 has an insertion portion 121 at one end remote from the lock core 13. The insertion portion 121 is a groove formed in the side wall of the locking sleeve 12. The wall surface of the insertion protrusion 511 of the first movable folding plate 51 has a protruding lock block 511a. When the first movable folding plate 51 is inserted, the insertion portion 121 allows the lock block 511a to be inserted into the locking sleeve 12, forming the unlocked state as shown in FIG. 4.

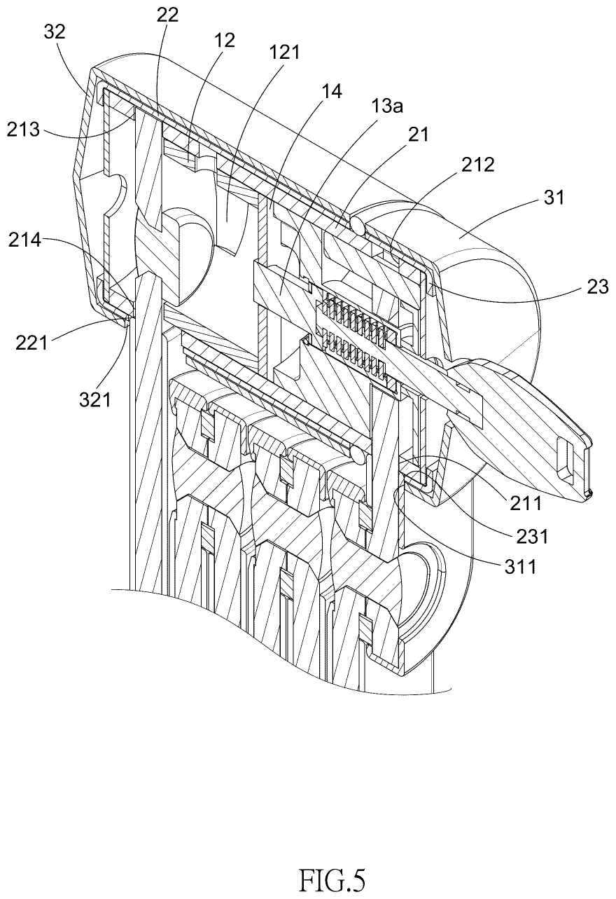

Referring to FIG. 5, when the user rotates the key 70 to cause the rotational shaft 13a to rotate forward, the locking sleeve 12 simultaneously rotates forward, causing the lock block 511a to enter and abut against the inner wall surface of the locking sleeve 12, preventing the first movable folding plate 51 from being pulled out and forming the locked state.

In the embodiment of the present disclosure, the sleeve assembly 20 includes an inner sleeve 21, a first outer sleeve 22, and a second outer sleeve 23. The locking sleeve 12 and the lock core 13 are disposed within the inner sleeve 21. The first outer sleeve 22 is sleeved over the outer side of the inner sleeve 21 from the left side, and the second outer sleeve 23 is sleeved over the outer side of the inner sleeve 21 from the right side, so that the sleeve assembly 20 covers the locking sleeve 12 to increase the structural strength of the folding lock. By restricting the movement of the lock block 511a of the insertion protrusion 511 of the first movable folding plate 51 with the locking sleeve 12 and by the arrangement of the sleeve assembly 20, the locking sleeve 12 is restricted to rotate only back and forth, preventing the first movable folding plate 51 from being easily damaged and pulled out in the locked state of the folding lock.

Both the inner sleeve 21 and the first outer sleeve 22 have openings 214 and 221 corresponding to the insertion portion 121. The openings 214 and 221, and the insertion portion 121, are arranged along the Y-axis direction. When the user wants to insert the first movable folding plate 51 into the lock body 10, the first movable folding plate 51 is inserted upward from the bottom of the lock body 10 into the openings 214 and 221, and the insertion portion 121.

Furthermore, the side wall of the inner sleeve 21 has a retaining groove 213 coaxially arranged with the openings 214 and 221. When the first movable folding plate 51 is inserted, the upper portion of the insertion protrusion 511 is restricted within the retaining groove 213, and the lower portion of the insertion protrusion 511 is positioned within the openings 214 and 221. The main purpose of the retaining groove 213 is to limit the movement of the insertion protrusion 511, allowing the first movable folding plate 51 to be more stably positioned within the inner sleeve 21 to improve usability.

More particularly, the connecting assembly 60 has a fixing portion 61 and a connecting portion 62, and the connecting portion 62 extends downward along the Y-axis direction from the fixing portion 61. The second outer sleeve 23 and the inner sleeve 21 have corresponding insertion holes 231 and 211 arranged along the Y-axis direction, to allow the fixing portion 61 of the connecting assembly 60 to be inserted upward along the Y-axis direction through the insertion holes 231 and 211 and fixed inside the lock body 10. In the embodiment of the present disclosure, the fixing portion 61 is fixed to the outer casing of the lock core 13.

Additionally, the inner sleeve 21 also has a fixing groove 212 coaxially arranged with the insertion hole 211. When the fixing portion 61 of the connecting assembly 60 is inserted, the upper portion of the fixing portion 61 is restricted within the fixing groove 212, and the lower portion of the fixing portion 61 is restricted within the insertion hole 211. Wherein, the fixing groove 212 and the retaining groove 213 are positioned on the extreme left and right sides of the side wall of the inner sleeve 21.

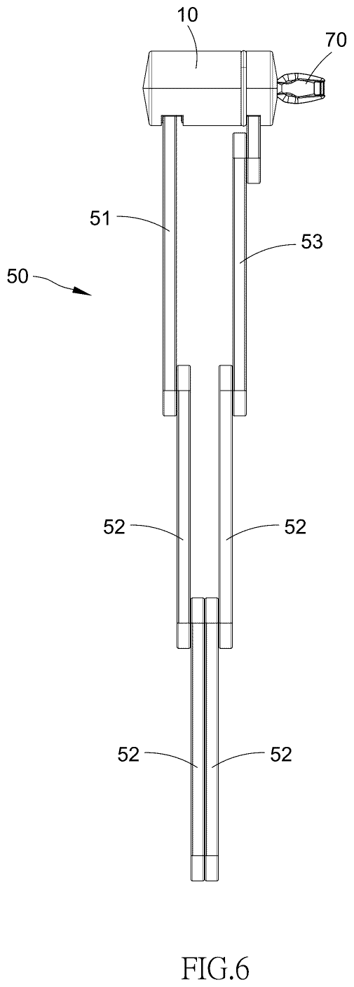

When the user wants to pull the first movable folding plate 51 out of the lock body 10, in addition to rotating the locking sleeve 12 to align the insertion portion 121 with the openings 214 and 221 of the sleeve assembly 20, it is also necessary to unfold the plurality of intermediate folding plates 52 of the folding plate assembly into the state shown in FIG. 6, to allow the first movable folding plate 51 to be pulled out of the lock body 10. This feature increases the overall strength of the folding lock and effectively prevents it from being damaged by malicious individuals.

More particularly, the folding lock of the present disclosure further has an outer casing 32 sleeved over the outer side of the first outer sleeve 22, and an end cap 31 sleeved over the outer side of the second outer sleeve 23. The outer casing 32 and the end cap 31 both have openings 321 and 311, respectively, for the first movable folding plate 51 and the connecting assembly 60 to be inserted into the lock body 10. The outer casing 32 and the end cap 31 serve as protective structures to prevent the sleeve assembly 20 from being damaged. Additionally, the end cap 31 has a keyhole 31a for inserting the key 70 into the lock core 13.

In the present disclosure, the locking or unlocking state is achieved by restricting the movement of the lock block 511a of the insertion protrusion 511 of the first movable folding plate 51 with the locking sleeve 12. The sleeve assembly 20 serves as a reinforcing structure by limiting the locking sleeve 12 to rotate only back and forth, which increases the overall structural strength, makes the folding lock difficult to be damaged, and achieves a better anti-theft effect.

What is claimed is:

1. A folding lock, comprising:
a lock body having a locking structure disposed within a sleeve assembly, the locking structure including a locking sleeve and a lock core connected to each other, the lock core driving the locking sleeve to rotate back and forth along an X-axis direction, the locking sleeve having an insertion portion at one end remote from the lock core, the sleeve assembly having at least two sleeves, each of the at least two sleeves having an opening corresponding to the insertion portion, the openings and the insertion portion being arranged along a Y-axis direction, and the lock core having a keyhole arranged along a Z-axis direction;
a folding plate assembly having a first movable folding plate, a second movable folding plate, and a plurality of intermediate folding plates connected to each other, the first movable folding plate having an insertion protrusion that is inserted upward along the Y-axis direction into the insertion portion; and
a connecting assembly having one end fixed inside the lock body and the other end connected to the second movable folding plate.

2. The folding lock according to claim 1, wherein the sleeve assembly comprises an inner sleeve, a first outer sleeve, and a second outer sleeve, the locking structure being disposed within the inner sleeve, and the first outer sleeve and the second outer sleeve being simultaneously sleeved over an outer side of the inner sleeve.

3. The folding lock according to claim 2, wherein the lock body further has an outer casing sleeved over an outer side of the first outer sleeve, and an end cap sleeved over an outer side of the second outer sleeve.

4. The folding lock according to claim 2, wherein the inner sleeve and the first outer sleeve both have an opening corresponding to the insertion portion, and a side wall of the inner sleeve has a retaining groove that is coaxially arranged with the openings.

5. The folding lock according to claim 2, wherein the second outer sleeve and the inner sleeve have corresponding insertion holes arranged along the Y-axis direction for the connecting assembly to be inserted into the lock body.

6. The folding lock according to claim 5, wherein the inner sleeve further comprises a fixing groove coaxially arranged with the insertion hole for fixing the connecting assembly.

7. The folding lock according to claim 5, wherein the connecting assembly comprises a fixing portion and a connecting portion, the connecting portion extending downward along the Y-axis direction from the fixing portion, the fixing portion being inserted upward along the Y-axis direction through the insertion holes and fixed inside the lock body.

8. The folding lock according to claim 3, wherein the outer casing and the end cap both have an opening.
